(19) United States
(12) Patent Application Publication
(10) Pub. No.: US 2023/0080783 A1
(43) Pub. Date: Mar. 16, 2023

(54) TRANSMISSION DEVICE, RECEPTION DEVICE, RADIO COMMUNICATION SYSTEM, CONTROL CIRCUIT, AND STORAGE MEDIUM

(71) Applicant: Mitsubishi Electric Corporation, Tokyo (JP)

(72) Inventor: Akinori NAKAJIMA, Tokyo (JP)

(73) Assignee: Mitsubishi Electric Corporation, Tokyo (JP)

(21) Appl. No.: 17/990,911

(22) Filed: Nov. 21, 2022

Related U.S. Application Data
(63) Continuation of application No. PCT/JP2020/021939, filed on Jun. 3, 2020.

(51) Int. Cl. H04L 27/26; H04L 27/20

(52) U.S. Cl. CPC H04L 27/2675; H04L 27/2082

(57) ABSTRACT

A transmission device includes: a reference sequence obtaining unit that obtains a reference sequence having a symbol sequence length equal to or smaller than a modulation order in a modulation method used for data transmission, the reference sequence having a constant amplitude in a time domain and a frequency domain; and a multiplexing unit that transmits a signal including the reference sequence.

### CROSS-REFERENCE TO RELATED APPLICATION

This application is a continuation application of International Application PCT/JP2020/021939, filed on Jun. 3, 2020, and designating the U.S., the entire contents of which are incorporated herein by reference.

### BACKGROUND OF THE INVENTION

### 1. Field of the Invention

The present disclosure relates to a transmission device that transmits training sequences, a reception device, a radio communication system, a control circuit, and a storage medium.

### 2. Description of the Related Art

For stable operation of a radio communication system, it is important to keep track of the radio environment and, upon occurrence of a problem, quickly and properly identify the problem. Use of a technology of analyzing radio environment using a training sequence makes it possible to keep track of radio environment without stopping the operation of a radio communication system. For example, as taught in Non Patent Literature 1, “3GPP TS36.212 V9.2.0,3rd Generation Partnership Project; Technical Specification Group Radio Access Network; Evolved Universal Terrestrial Radio Access(E-UTRA); Physical Layer Procedures(Release9), 2010-06”, a constant amplitude zero auto-correlation (CAZAC) sequence is used as a training sequence called an uplink reference signal in long term evolution (LTE) systems standardized as 4th generation cellular radio communication systems in the 3rd generation partnership project (3GPP). In addition, Non Patent Literature 2, “Zhi-Cheng Feng, et al., “BER Performance of Chirp QPSK in Multipath Channel”, Proc. of IEEE ICECC, pp. 1349-1352, 2011″ also teaches a technology of applying a CAZAC sequence to an information sequence. A CAZAC sequence has characteristics of having a constant amplitude in the time domain and the frequency domain. Use of a CAZAC sequence enables makes it possible to estimate a frequency response with high accuracy and relatively easily.

When a CAZAC sequence is periodically inserted as a training sequence between modulated signals used in existing systems, the boundaries between data and the training signal unfortunately become discontinuous, which causes a problem of degradation in the peak to average power ratio (PAPR) of the waveform. Furthermore, when a CAZAC sequence is applied to an information sequence as well, the boundaries between sequences become discontinuous, which degrades the PAPR. As described above, a problem with transmission using a CAZAC sequence is degradation of the PAPR. In order to minimize degradation in the PAPR, the modulation method needs changing. A radio communication system in conformity with a radio standard specifying a modulation method fails to prevent the degradation of the PAPR.

### SUMMARY OF THE INVENTION

To solve the above problem, a transmission device according to the present disclosure comprises: a reference sequence obtaining unit to obtain a reference sequence having a symbol sequence length equal to or smaller than a modulation order in a modulation method used for data transmission, the reference sequence having a constant amplitude in a time domain and a frequency domain; and a transmission unit to transmit a signal including the reference sequence.

### BRIEF DESCRIPTION OF THE DRAWINGS

FIG. 1 is a diagram illustrating a configuration of a transmission device according to a first embodiment;

FIG. 2 is a diagram illustrating a structure of a transmission symbol sequence generated by a multiplexing unit illustrated in FIG. 1;

FIG. 3 is a diagram for explaining a reference sequence obtained by a reference sequence obtaining unit illustrated in FIG. 1;

FIG. 4 is a diagram illustrating a spectrum in the frequency domain of a reference sequence obtained by the reference sequence obtaining unit illustrated in FIG. 1;

FIG. 5 is a diagram illustrating an example of a training sequence generated by a training sequence generating unit illustrated in FIG. 1;

FIG. 6 is a diagram illustrating a configuration of a reception device that receives a signal transmitted by the transmission device illustrated in FIG. 1;

FIG. 7 is a diagram illustrating a configuration of a transmission device according to a modification to the first embodiment;

FIG. 8 is a diagram for explaining a constellation of a reference sequence in a case where 2^{M}-QAM is used as a modulation method;

FIG. 9 is a diagram illustrating a configuration of a transmission device according to a second embodiment;

FIG. 10 is a diagram illustrating a configuration of a reception device according to the second embodiment;

FIG. 11 is a diagram for explaining a reference sequence obtained by a reference sequence obtaining unit of the transmission device illustrated in FIG. 9;

FIG. 12 is a diagram illustrating constellations of a reference sequence obtained by the reference sequence obtaining unit illustrated in FIG. 9;

FIG. 13 is a diagram illustrating a spectrum in a case where a training sequence generated by a training sequence generating unit illustrated in FIG. 9 is converted into frequency;

FIG. 14 is a diagram illustrating a configuration of a transmission device of the second embodiment in a case where a reference sequence that is a CAZAC sequence is applied to a data symbol sequence;

FIG. 15 is a diagram illustrating a configuration of a reception device of the second embodiment in a case where a reference sequence that is a CAZAC sequence is applied to a data symbol sequence;

FIG. 16 is a diagram illustrating dedicated hardware for implementing the functions of the transmission device and the reception device according to the first and second embodiments; and

FIG. 17 is a diagram illustrating a configuration of a control circuit for implementing the functions of the transmission device and the reception device according to the first and second embodiments.

### DETAILED DESCRIPTION OF THE PREFERRED EMBODIMENTS

A transmission device, a reception device, a radio communication system, a control circuit, and a storage medium according to certain embodiments of the present disclosure will be described in detail below with reference to the drawings.

### First Embodiment

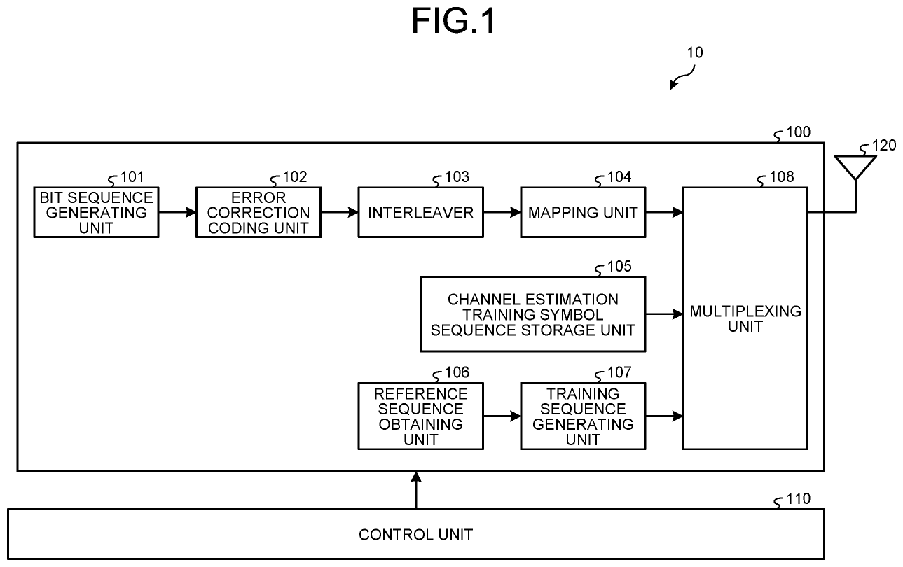

FIG. 1 is a diagram illustrating a configuration of a transmission device 10 according to a first embodiment. The transmission device 10 includes a modulation unit 100, a control unit 110, and a transmission antenna unit 120. The modulation unit 100 includes a bit sequence generating unit 101, an error correction coding unit 102, an interleaver 103, a mapping unit 104, a channel estimation training symbol sequence storage unit 105, a reference sequence obtaining unit 106, a training sequence generating unit 107, and a multiplexing unit 108.

The bit sequence generating unit 101 generates an information bit sequence of data to be included in a transmission signal. The bit sequence generating unit 101 outputs the generated information bit sequence to the error correction coding unit 102. The error correction coding unit 102 performs error correction coding on the information bit sequence generated by the bit sequence generating unit 101. The error correction coding unit 102 outputs, to the interleaver 103, a coded bit sequence resulting from the coding. The interleaver 103 changes the order of the coded sequence output from the error correction coding unit 102. The interleaver 103 outputs, to the mapping unit 104, the coded sequence having its order changed. The mapping unit 104 maps the coded sequence output from the interleaver 103 to generate a data symbol sequence that is first-order modulated symbols. The mapping unit 104 outputs the generated data symbol sequence to the multiplexing unit 108.

The channel estimation training symbol sequence storage unit 105 stores a training pilot sequence for channel estimation, and can provide the multiplexing unit 108 with the stored training pilot sequence.

The reference sequence obtaining unit 106 obtains a reference sequence that is a CAZAC sequence. The CAZAC sequence has a constant amplitude in the time domain and the frequency domain. The reference sequence is a CAZAC sequence that is used for generating a training sequence which the transmission device 10 includes in a transmission signal, and such a CAZAC sequence is in conformity with a rule associated with the modulation method used by the modulation unit 100. The reference sequence obtaining unit 106 includes, for example, a storage unit for storing a reference sequence calculated in advance in conformity with the modulation method used by the modulation unit 100. In this case, the reference sequence obtaining unit 106 may store a plurality of kinds of reference sequences, select a reference sequence to be used, in accordance with an instruction from the control unit 110, and output the selected reference sequence to the training sequence generating unit 107.

In addition, the reference sequence obtaining unit 106 may include a function of calculating a reference sequence in accordance with an instruction from the control unit 110. In this case, the reference sequence obtaining unit 106 may receive such parameters as a null insertion rate and a sequence index from the control unit 110, and calculate, on the basis of the parameters, a reference sequence that is a symbol sequence of a CAZAC sequence in conformity with a rule associated with the modulation method used by the modulation unit 100. The reference sequence obtaining unit 106 outputs the obtained reference sequence to the training sequence generating unit 107.

On the basis of the reference sequence output from the reference sequence obtaining unit 106, the training sequence generating unit 107 generates a training sequence to be used for analyzing the radio environment. Specifically, the training sequence generating unit 107 generates a training sequence by repeating symbols included in the reference sequence. The training sequence generating unit 107 outputs, to the multiplexing unit 108, the generated training sequence, i.e., a training pilot sequence for radio wave environment analysis.

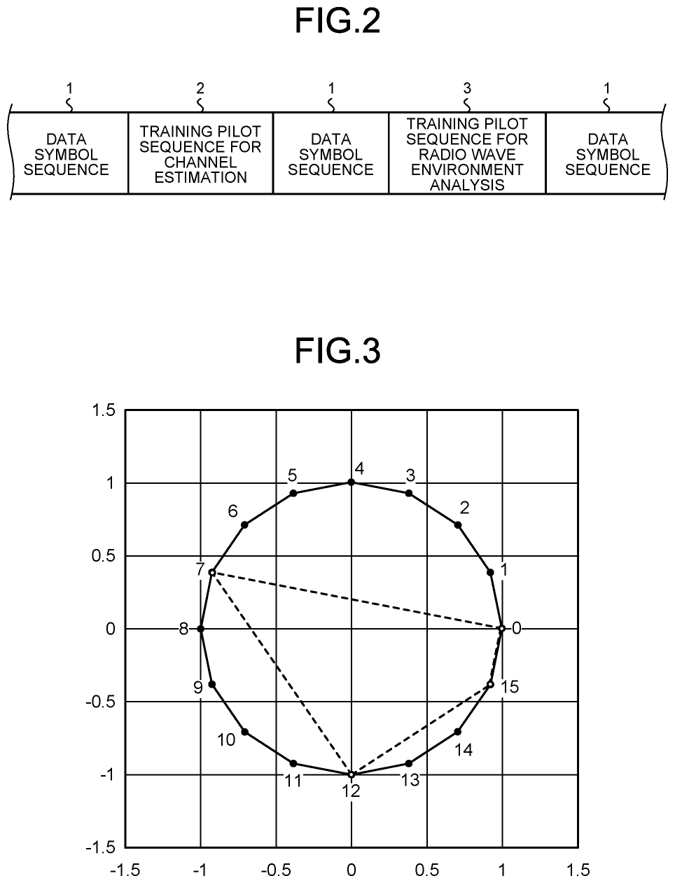

FIG. 2 is a diagram illustrating a structure of a transmission symbol sequence generated by the multiplexing unit 108 illustrated in FIG. 1. The multiplexing unit 108 receives input of data symbol sequences 1 output from the mapping unit 104, a training pilot sequence 2 for channel estimation stored in the channel estimation training symbol sequence storage unit 105, and a training pilot sequence 3 for radio wave environment analysis output from the training sequence generating unit 107. The multiplexing unit 108 performs a multiplexing process in accordance with an instruction from the control unit 110 to thereby periodically insert the training pilot sequence 2 for channel estimation and the training pilot sequence 3 for radio wave environment analysis, individually between data symbol sequences 1.

The multiplexing unit 108 is a transmission unit that transmits, via the transmission antenna unit 120, a transmission signal including the generated transmission symbol sequence. In other words, the multiplexing unit 108 is a transmission unit that transmits a signal including a reference sequence.

Next, a reference sequence obtained by the reference sequence obtaining unit 106 will be described. With a CAZAC sequence simply inserted between modulated data symbol sequences, the boundary between data and the training sequence is discontinuous, which causes problems of degradation in the spectral characteristics and degradation in the PAPR. In view of this, the reference sequence obtaining unit 106 obtains a reference sequence that is a CAZAC sequence conforming with a rule associated with the modulation method used by the modulation unit 100.

Specifically, the reference sequence obtaining unit 106 obtains a reference sequence having a sequence length N and satisfying formula (1). The sequence length N is a symbol sequence length of a modulation order 2^{M} or smaller of the modulation method used for data transmission. Note that the symbol sequence length is a data length of a sequence expressed in terms of a symbol. Formula (1) is a general formula of a CAZAC sequence. The reference sequence obtaining unit 106 generates a reference sequence that is a CAZAC sequence, using candidate points that are selected some or all of 2^{M} transmission candidate points in the modulation method used for data transmission.

$$\begin{matrix}[ Formula 1 ] & \\ \{ \begin{matrix}\begin{matrix}c ( t ) = exp \{ - j \frac{π u {t}^{2}}{N} \} & if N even number\end{matrix} \\ c ( t ) = exp \{ - j \frac{π u t ( t + 1 )}{N} \} otherwise\end{matrix} & ( 1 )\end{matrix}$$

In one example, the reference sequence obtaining unit 106 can obtain the reference sequence having the sequence length N satisfying a relation with the modulation order 2^{M} as indicated by formula (2) below.

[Formula 2]

2^{M}=N (2)

Satisfying formula (2) means that the minimum phase rotation amount in a CAZAC sequence is equal to the minimum phase unit of phase modulation that is used. The reference sequence, which is a CAZAC sequence that satisfies formula (2), can provide a flat spectrum over the used band when the reference sequence is subjected to frequency conversion through discrete Fourier transform of N points. In this case, the frequency response of a propagation path can be checked.

In addition, the reference sequence obtaining unit 106 can obtain the reference sequence having the sequence length N satisfying a relation with the modulation order 2^{M} as indicated by formula (3) below. In other words, reference sequence obtaining unit 106 determines the sequence length N of the reference sequence so that the product of an integer “a” and the sequence length N of the reference sequence is equal to the modulation order 2^{M} or a value obtained by dividing the modulation order 2^{M} by 2.

[Formula 3]

2^{M}=2aN (3)

In formula (3), reference character “a” represents an integer. As the reference sequence is a CAZAC sequence having the sequence length N satisfying formula (3), the reference sequence can form null regions in the frequency domain in addition to the flat spectrum when the reference sequence is subjected to discrete Fourier transform of an integral multiple of the number of points amounting to the order of phase modulation. As a result, it becomes possible to analyze the radio wave environment including interference detection, using the null regions.

For example, a description will be made assuming that the modulation method used by the modulation unit 100 is 16 phase shift keying (PSK) where M=4 and a=1. N=8 is obtained using formula (2) above, and the sequence length of the reference sequence is therefore 8 symbol periods. FIG. 3 is a diagram for explaining the reference sequence obtained by the reference sequence obtaining unit 106 illustrated in FIG. 1. In the case of u=1, for example, the reference sequence draws a locus of eight symbols in a period, which are 0, 15, 12, 7, 0, 7, 12, and 15, as illustrated in FIG. 3.

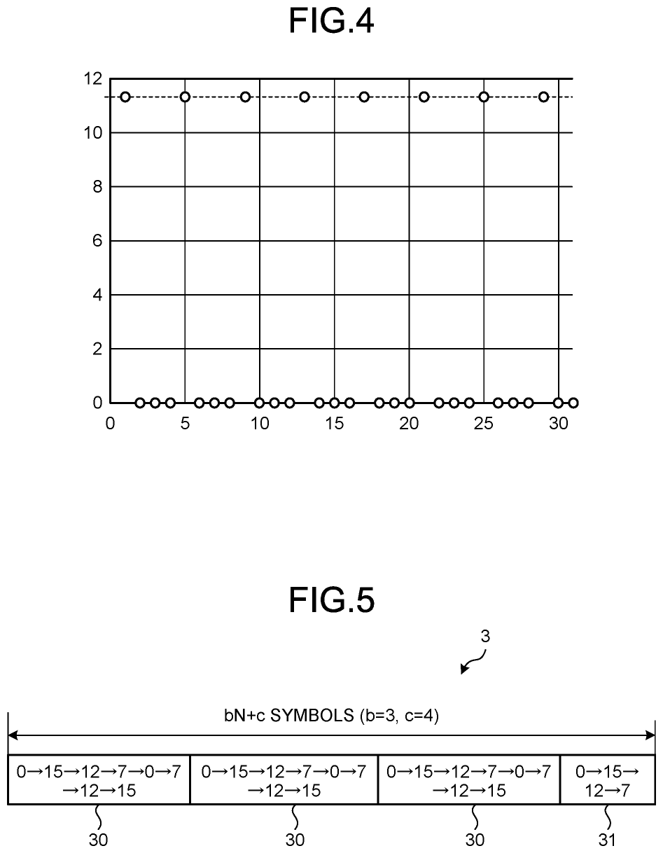

When discrete Fourier transform of 32 points, which are twice the order 16 of 16PSK, is performed, the sequence is repeated four times within a period of fast Fourier transform because a CAZAC sequence in the time domain has eight symbols in a period. FIG. 4 is a diagram illustrating a spectrum in the frequency domain of a reference sequence obtained by the reference sequence obtaining unit 106 illustrated in FIG. 1. As illustrated in FIG. 4, in the frequency domain, the reference sequence has eight peaks with the constant amplitude, and the frequency components other than the peaks are null.

FIG. 5 is a diagram illustrating an example of a training sequence generated by the training sequence generating unit 107 illustrated in FIG. 1. The training sequence generating unit 107 generate a training pilot sequence 3 for radio wave environment analysis. The training pilot sequence 3 is a training sequence including the reference sequence 30 obtained by the reference sequence obtaining unit 106. For example, the training sequence generating unit 107 generates a training sequence of bN+c symbols by adding “c” symbol sequences 31 to a symbol sequence having the reference sequence 30 repeated an integer “b” times. The “c” symbols, which are 1st to cth symbols from the beginning of the reference sequence, are provided for reducing multipath delay and synchronization error. FIG. 5 illustrates an example in which the modulation method is 16PSK, b=3, and c=4. The training pilot sequence 3 for radio wave environment analysis that is a training sequence illustrated in FIG. 5 is obtained by repeating the reference sequence 30 three times and adding the symbol sequence 31 for reducing the influence of multiple paths. When the training sequence has a sequence length as described above, analysis of a frequency response can cover up to a delay profile of c-symbol delay as a result of discrete Fourier transform of a CAZAC sequence of c symbols. In addition, as a result of using the training sequence as described above, null regions are formed in the frequency domain and a frequency response is estimated as well, which enables interference detection to be performed simultaneously. Note that, even when the sequence length N is an odd number, it is also applicable provided that the minimum phase unit in the modulation method is an integral multiple of the minimum phase unit of the CAZAC sequence having the sequence length N when the number of candidate points in the modulation method being used is X. In other words, this is applicable when the relation of X=aN is satisfied.

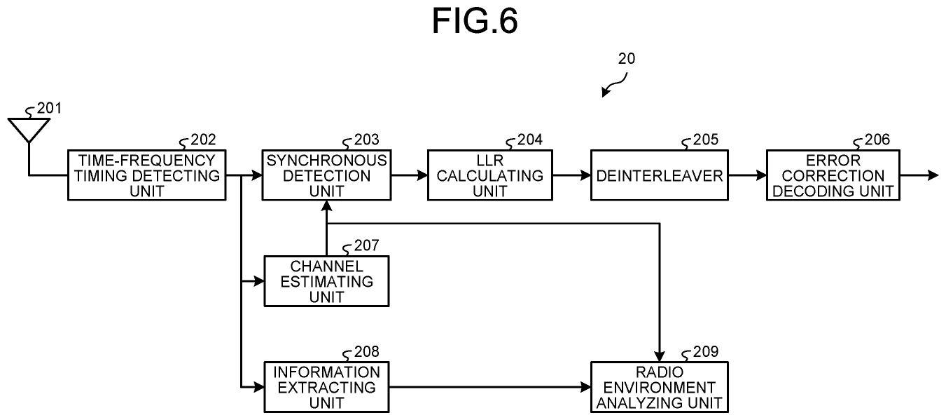

FIG. 6 is a diagram illustrating a configuration of a reception device 20 that receives a signal transmitted by the transmission device 10 illustrated in FIG. 1. The reception device 20 includes a reception antenna unit 201, a time-frequency timing detecting unit 202, a synchronous detection unit 203, a log likelihood ratio (LLR) calculating unit 204, a deinterleaver 205, an error correction decoding unit 206, a channel estimating unit 207, an information extracting unit 208, and a radio environment analyzing unit 209.

Upon receiving a signal transmitted by the transmission device 10, the reception antenna unit 201 outputs the received signal to the time-frequency timing detecting unit 202. The time-frequency timing detecting unit 202 performs time synchronization and frequency synchronization through correlation processing using the received signal. The time-frequency timing detecting unit 202 outputs the received signal to the synchronous detection unit 203, the channel estimating unit 207, and the information extracting unit 208.

The channel estimating unit 207 performs channel estimation, using a training pilot sequence 2 for channel estimation included in the received signal. The channel estimating unit 207 outputs a resulting channel estimation value to the synchronous detection unit 203 and the radio environment analyzing unit 209.

Using the channel estimation value output from the channel estimating unit 207, the synchronous detection unit 203 performs a synchronous detection process on a data symbol sequence 1 included in the received signal. The synchronous detection unit 203 outputs, to the LLR calculating unit 204, the received signal having been subjected to the synchronous detection process.

The LLR calculating unit 204 performs an LLR calculation process on the basis of the received signal output from the synchronous detection unit 203. The LLR calculating unit 204 outputs the calculated LLR sequence to the deinterleaver 205.

The deinterleaver 205 performs a deinterleaving process of returning the order of a coded sequence, which was changed by the interleaver 103 of the transmission device 10, back to the original order. The deinterleaver 205 outputs, to the error correction decoding unit 206, the resulting coded sequence having been subjected to the deinterleaving process.

The error correction decoding unit 206 performs a decoding process on the coded sequence output from the deinterleaver 205 and obtains an information bit sequence. The error correction decoding unit 206 outputs the obtained information bit sequence.

Using the training pilot sequence 3 for radio wave environment analysis, i.e., a training sequence included in the received signal, the information extracting unit 208 extracts radio environment information on a desired wave to be used by the subsequent radio environment analyzing unit 209. The information extracting unit 208 performs discrete Fourier transform at predetermined timing. Because the training pilot sequence 3 for radio wave environment analysis, which is a training sequence included in the received signal, includes its signal spectrum and null regions, the information extracting unit 208 extracts, from the received signal, frequency components corresponding to that signal spectrum, and estimates a frequency response of a propagation path of the desired wave. The information extracting unit 208 further extracts, from the received signal, frequency components corresponding to null regions, and calculates received power in the null regions to thereby estimate interference power and an interference bandwidth. The information extracting unit 208 outputs, to the radio environment analyzing unit 209, radio environment information including the frequency response of the propagation path of the desired wave, the received power, the interference power, and the interference bandwidth of the desired wave, etc. Note that the radio environment information output by the information extracting unit 208 may include a signal to interference ratio (SIR) combining the received power and the interference power of the desired wave.

The radio environment analyzing unit 209 performs a process of analyzing radio environment between the transmission device 10 and the reception device 20 on the basis of the channel estimation value output from the channel estimating unit 207 and the radio environment information output from the information extracting unit 208. The radio environment analyzing unit 209 can analyze the radio wave environment of a radio communication system, such as the tendency of occurrence of interference waves, a direction from which an interference wave arrives, a bandwidth of an interference wave, the modulation method of an interference wave, buildings around a system in which the radio environment analyzing unit 209 is included, and a change in the radio wave environment caused by a disaster. Because the present embodiment can transmit a CAZAC sequence without changing the modulation method, the information extracting unit 208 can extract radio environment information with high accuracy. The radio environment analyzing unit 209 can therefore obtain the radio wave environment in more detail. While the reception device 20 as discussed herein includes the radio environment analyzing unit 209, the present embodiment is not limited to this example. The radio environment analyzing unit 209 may be included in a server, etc. other than the reception device 20. For example, a server that monitors communication between transmission devices 10 and reception devices 20 may collect radio environment information from a plurality of reception devices 20.

Note that the training pilot sequence 3 for radio wave environment analysis may be identical to the training pilot sequence 2 for channel estimation. When the training pilot sequence 3 for radio wave environment analysis is identical to the training pilot sequence 2 for channel estimation, the frequency response can be estimated, which is advantageous in that equalization in the frequency domain can be achieved. In addition, a sequence satisfying formula (2) or formula (3) may be used for a channel estimation training pilot sequence 2. In this case, an accurate frequency response can be estimated, and an equalization process with this estimated frequency response can achieve an effect of improving the communication performance. Furthermore, an equalization process can be performed using the training pilot sequence 3 for radio wave environment analysis.

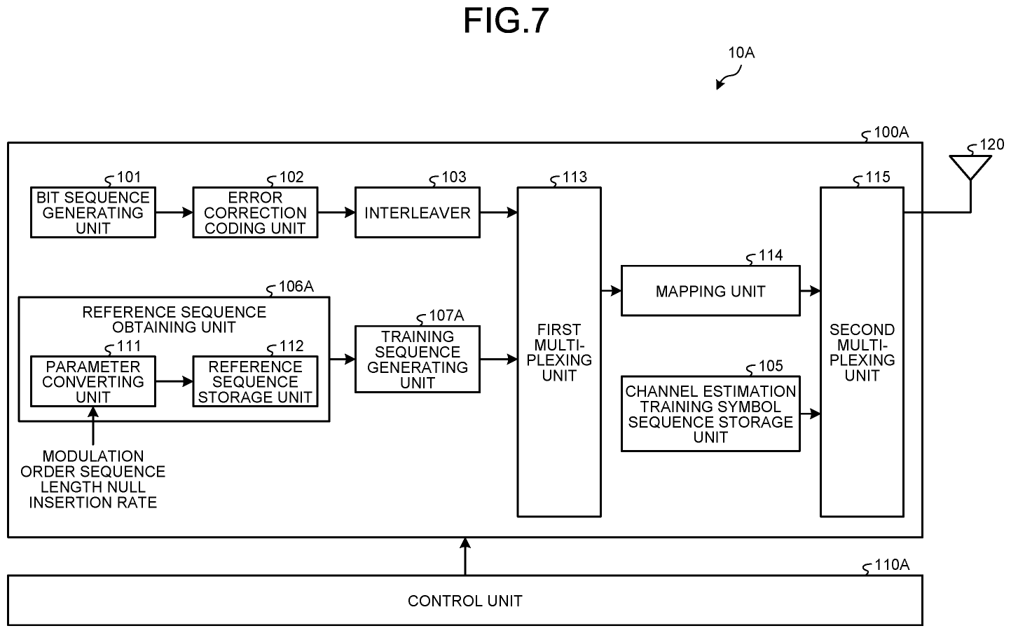

FIG. 7 is a diagram illustrating a configuration of a transmission device 10A according to a modification to the first embodiment. The transmission device 10A includes a modulation unit 100A and a control unit 110A. The modulation unit 100A includes the bit sequence generating unit 101, the error correction coding unit 102, the interleaver 103, the channel estimation training symbol sequence storage unit 105, a reference sequence obtaining unit 106A, a training sequence generating unit 107A, a first multiplexing unit 113, a mapping unit 114, and a second multiplexing unit 115.

Components similar to those of the transmission device 10 in FIG. 1 will be represented by the same reference numerals as those in FIG. 1, detailed description thereof will be omitted, and differences from FIG. 1 will be mainly described below. In the transmission device 10, the multiplexing unit 108 multiplexes the data symbol sequences 1, the training pilot sequence 2 for channel estimation, and the training pilot sequence 3 for radio wave environment analysis to thereby generate a transmission symbol sequence, whereas in the present embodiment, pre-mapping bit sequences, or a data bit sequence and a training sequence that is a bit sequence are time-multiplexed.

A data bit sequence output from the interleaver 103 is output to the first multiplexing unit 113. While the reference sequence obtained by the reference sequence obtaining unit 106 is a symbol sequence, a reference sequence obtained by the reference sequence obtaining unit 106A is a bit sequence. The reference sequence obtaining unit 106A includes a parameter converting unit 111, and a reference sequence storage unit 112. The parameter converting unit 111 receives, from the control unit 110A, parameters such as a modulation order, a sequence length of a bit sequence for radio wave environment analysis, a ratio (b−1)/b of null regions to a discrete Fourier transform period, an index u of a used bit sequence, and a supported multipath delay amount c. From the parameters received from the control unit 110A, the parameter converting unit 111 instructs the reference sequence storage unit 112 to output a reference sequence of (bN+c)M bits with an indicated sequence index u, on the basis of mapping to be used.

In accordance with the instruction from the parameter converting unit 111, the reference sequence storage unit 112 outputs a bit sequence of (bN+c)M bits with a reference sequence having the constellation of 16PSK with the order of 0, 15, 12, 7, 0, 7, 12, and 15 to the training sequence generating unit 107A where the modulation method to be used is, for example, 16PSK. The training sequence generating unit 107A outputs, to the first multiplexing unit 113, a training sequence, i.e., the bit sequence of (bN+c)M bits output from the reference sequence storage unit 112.

The first multiplexing unit 113 time-multiplexes the data bit sequence output from the interleaver 103 and the reference sequence that is the bit sequence output from the training sequence generating unit 107A.

Note that the reference sequence storage unit 112 stores the reference sequence that is an NM-bit sequence corresponding to the sequence length N of the CAZAC sequence, and the reference sequence is repeatedly read on the basis of the parameters (b−1) and c to thereby generate a training sequence of (bN+c)M bits.

While the reference sequence obtaining unit 106A includes the reference sequence storage unit 112, the reference sequence obtaining unit 106A may directly calculate a reference sequence in the same manner as the reference sequence obtaining unit 106 illustrated in FIG. 1.

The first multiplexing unit 113 outputs, to the mapping unit 114, the bit sequence resulting from time multiplexing. The mapping unit 114 maps a coded sequence output from the first multiplexing unit 113 to thereby generate a symbol sequence that is first-order modulated symbols. The mapping unit 114 outputs the generated symbol sequence to the second multiplexing unit 115. The second multiplexing unit 115 is a transmission unit that multiplexes the symbol sequence output from the mapping unit 114 and a training pilot sequence 2 for channel estimation stored in the channel estimation training symbol sequence storage unit 105, and transmits the resulting sequence via the transmission antenna unit 120. In other words, the second multiplexing unit 115 is a transmission unit that transmits a signal including a reference sequence.

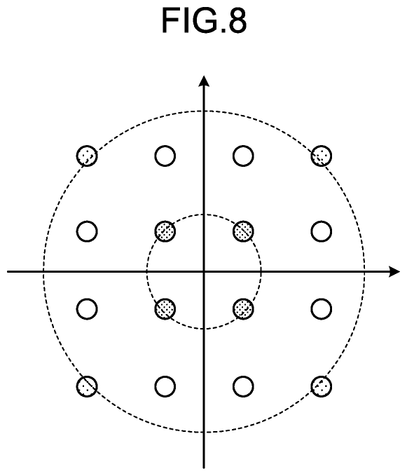

While the modulation method used by the transmission devices 10 and 10A is 16PSK as an example in the embodiment described above, the present embodiment is not limited to this example. The modulation method used by the transmission devices 10 and 10A may be 2^{M}-PSK, or amplitude phase shift keying (APSK). In the case of APSK, a plurality of circles are present, and a CAZAC sequence that satisfies formula (2) or (3) above for any of the circles may be generated. In the case where the modulation method used by the transmission device 10 or 10A is 2^{M}-quadrature amplitude modulation (QAM), a predetermined constellation may be used. FIG. 8 is a diagram for explaining a constellation of a reference sequence in the case where 2^{M}-QAM is used as the modulation method. For example, in the case of 16QAM, a reference sequence can be generated using two sets of four-point constellation illustrated in FIG. 8, and each of the constellations can be used in a manner corresponding to that in QPSK.

### Second Embodiment

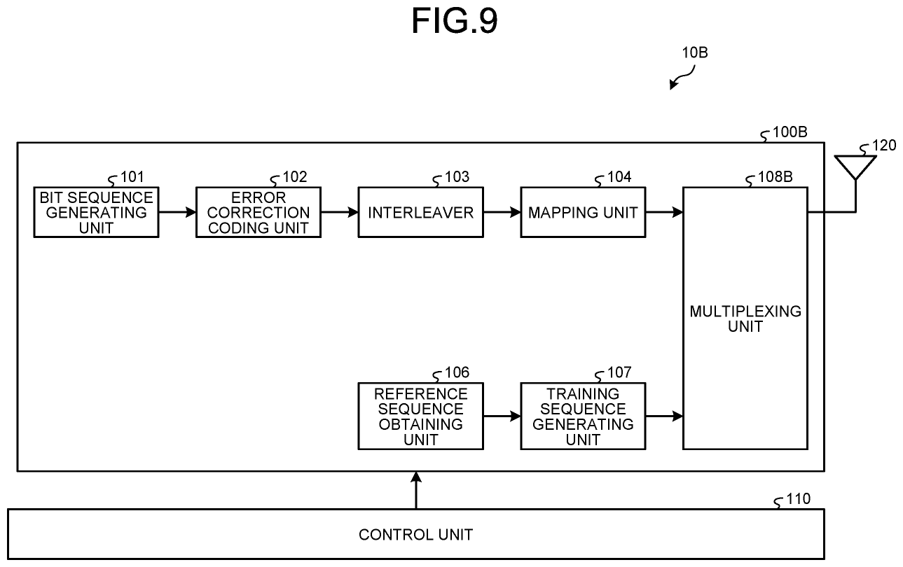

FIG. 9 is a diagram illustrating a transmission device 10B according to a second embodiment. The modulation method used by the transmission device 10B is n/4-shift differential quadrature phase shift keying (DQPSK). Because the transmission device 10B uses n/4-shift DQPSK, the training pilot sequence 2 for channel estimation is not basically used. Thus, the transmission device 10B does not include the channel estimation training symbol sequence storage unit 105.

The transmission device 10B includes a modulation unit 100B, the control unit 110, and the transmission antenna unit 120. The modulation unit 100B includes the bit sequence generating unit 101, the error correction coding unit 102, the interleaver 103, the mapping unit 104, the reference sequence obtaining unit 106, the training sequence generating unit 107, and a multiplexing unit 108B. Differences from the transmission device 10 illustrated in FIG. 1 will be hereinafter mainly described.

As mentioned above, the transmission device 10B does not include the channel estimation training symbol sequence storage unit 105. Thus, the multiplexing unit 108B is a transmission unit that multiplexes the data symbol sequence 1 output from the mapping unit 104 and the training pilot sequence 3 for radio wave environment analysis that is a training sequence generated by the training sequence generating unit 107, transmits the resulting sequence via the transmission antenna unit 120. In other words, the multiplexing unit 108B is a transmission unit that transmits a signal including a reference sequence.

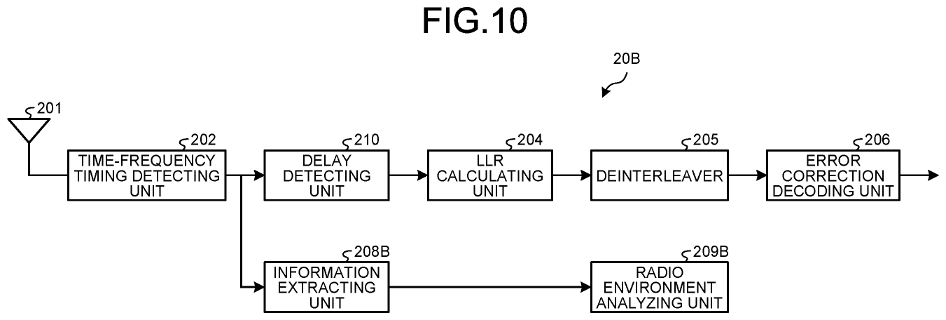

FIG. 10 is a diagram illustrating a configuration of a reception device 20B according to the second embodiment. The reception device 20B includes the reception antenna unit 201, the time-frequency timing detecting unit 202, the LLR calculating unit 204, the deinterleaver 205, the error correction decoding unit 206, an information extracting unit 208B, a radio environment analyzing unit 209B, and a delay detecting unit 210.

Differences from the reception device 20 illustrated in FIG. 1 will be hereinafter mainly described. The reception device 20B includes the delay detecting unit 210 instead of the synchronous detection unit 203 of the reception device 20, and does not include the channel estimating unit 207. Thus, the time-frequency timing detecting unit 202 outputs a received signal to each of the delay detecting unit 210 and the information extracting unit 208B. Because the reception device 20B uses n/4-shift DQPSK, the channel estimating unit 207 is not necessary in general. In the present embodiment, for the purpose of analyzing radio wave environment, the information extracting unit 208B estimate the frequency response of a propagation path, using the training pilot sequence 3 for radio wave environment analysis. The radio environment analyzing unit 209 analyzes the radio environment on the basis of radio environment information output from the information extracting unit 208B.

A description will be made as to a method for generating a symbol sequence of a CAZAC sequence in n/4-shift DQPSK. n/4-shift DQPSK has a characteristic in that the positions of the four-value constellations for even symbols differ from those for odd symbols, and the constellations are alternately switched in symbol sequences as viewed chronologically. Thus, in the present embodiment, in the case of using a modulation method having constellations alternately switched, a CAZAC sequence is generated in view of all possible constellations of even symbols and odd symbols.

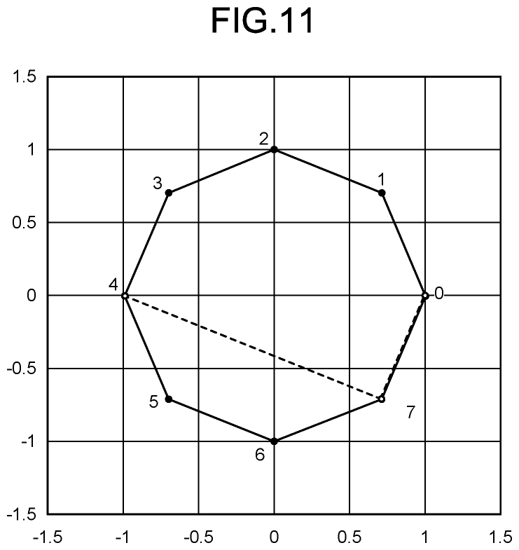

FIG. 11 is a diagram for explaining a reference sequence obtained by the reference sequence obtaining unit 106 of the transmission device 10B illustrated in FIG. 9. As illustrated in FIG. 11, in n/4-shift DQPSK, a possible constellation corresponds to that in 8PSK where M=3. In this case, a CAZAC sequence can be achieved by a constellation having four symbols in a period, which are 0, 7, 4, and 7.

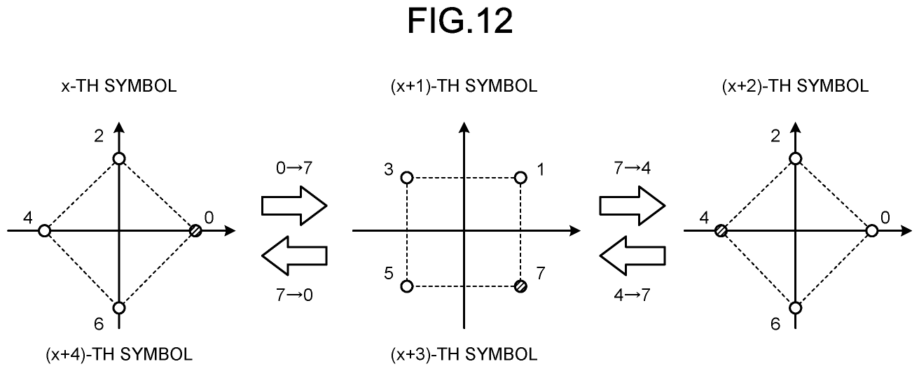

FIG. 12 is a diagram illustrating constellations of a reference sequence obtained by the reference sequence obtaining unit 106 illustrated in FIG. 9. In application to n/4-shift DQPSK in view of the above, as illustrated in FIG. 12, an x-th symbol of the reference sequence has a constellation in QPSK corresponding to that of the 0th symbol in 8PSK. In addition, the (x+1)-th symbol of the reference sequence has a constellation in n/4-shift QPSK corresponding to that of the 7th symbol in 8PSK. The constellations of subsequent symbols correspond to those of the 4th and the 7th symbols in 8PSK, which enables generation of a reference sequence that is a CAZAC sequence even in the case where the modulation method used by the transmission device 10B is n/4-shift DQPSK.

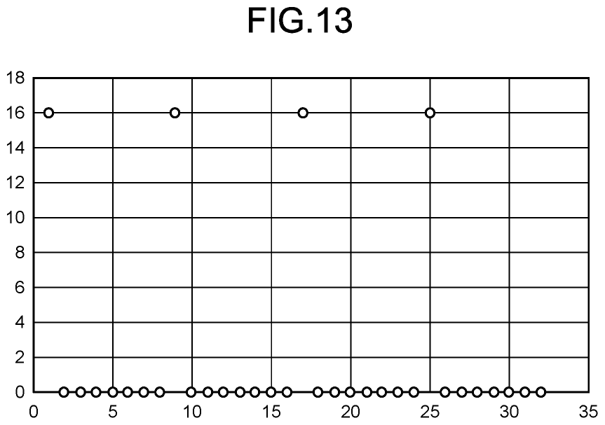

FIG. 13 is a diagram illustrating a spectrum in the case where a training sequence generated by the training sequence generating unit 107 illustrated in FIG. 9 is converted into frequency. The training sequence generating unit 107 generates a training sequence having a reference sequence, which is a CAZAC sequence of four symbols in a period, repeated b=8 times. FIG. 13 illustrates a result of performing discrete Fourier transform of 32 points on the training sequence generated by the training sequence generating unit 107. FIG. 13 shows that the CAZAC sequence is properly generated as the spectrum of the CAZAC sequence is observed with constant power at four frequencies and nulls are formed at frequencies other than the four frequencies.

Note that a reference sequence that is a CAZAC sequence is also applicable to a data symbol sequence. While the starting point of a reference sequence is the 0th point in the example illustrated in FIG. 11, the initial phase can be changed depending on the position of the starting point, such that the initial phase can be given information. A reference sequence that is a CAZAC sequence is applied to a data symbol sequence, and starting points are, for example, the 0th, the 2nd, the 4th, and the 6th points, in which case the initial phase of the reference sequence is changed but the phase rotation amount thereof is maintained. This enables two-bit transmission in four sequence patterns (0→7→4→7, 2→1→6→1, 4→3→0→3, and 6→5→2→5). Specifically, two-bit transmission can be performed by using one CAZAC sequence having four symbols, i.e., first to fourth symbols in one period, with information given to the initial phase that is the phase of the first symbol. This enables the data symbol sequence to maintain the wavelength characteristics and form a flat spectrum. As a result, for a data symbol sequence as well, the frequency response of a propagation path can be analyzed on a power basis. Furthermore, an effect of improving the reception performance can also be produced by transmitting the same data four times.

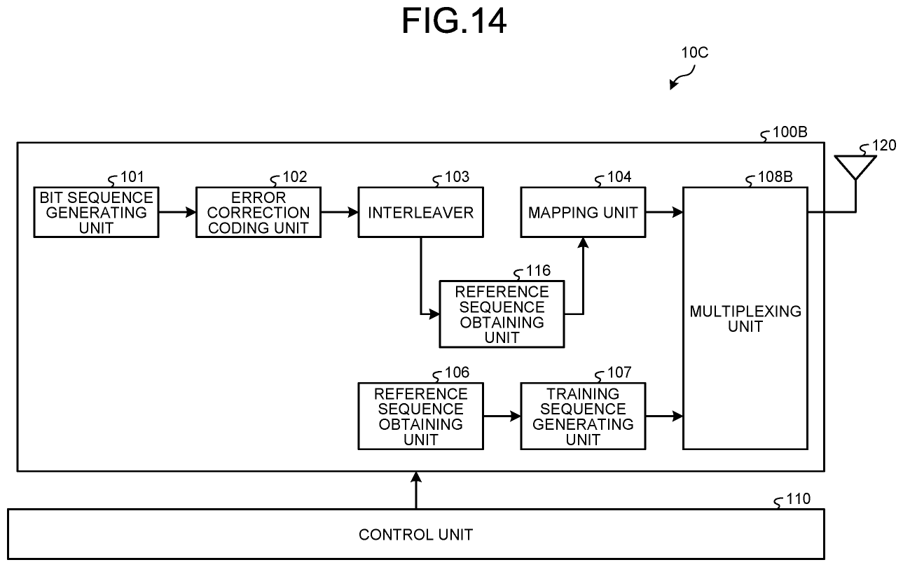

FIG. 14 is a diagram illustrating a configuration of a transmission device of the present embodiment in a case where a reference sequence that is a CAZAC sequence is applied to a data symbol sequence. In a transmission device 10C illustrated in FIG. 14, a bit sequence that is an information sequence output from the interleaver 103 is input to the reference sequence obtaining unit 116. The reference sequence obtaining unit 116 is a reference sequence obtaining unit for obtaining a reference sequence for data, which is a CAZAC sequence, two-bit-by-two-bit, using the input bit sequence. For example, the reference sequence obtaining unit 116 generates a data reference sequence that is a reference sequence in a sequence pattern 0→7→4→7 when the bit sequence is “00”, that is, when the first bit and the second bit are both “0”, in a sequence pattern 2→1→6→1 when the bit sequence is “01”, in a sequence pattern 4→3→0→3 when the bit sequence is “11”, and in a sequence pattern 6→5→2→5 when the bit sequence is “10”, and outputs the data reference sequence to the subsequent mapping unit 104. The mapping unit 104 performs mapping on the basis of the input data reference sequence to thereby generate first-order modulated symbols. The configuration and the operation of the transmission device 10C other than those described above are similar to those of the transmission device 10B. Thus, in the example illustrated in FIG. 14, the multiplexing unit 108B transmits a signal including the reference sequence for data and the training sequence. This reference sequence for data has information is assigned to the initial phase of the reference sequence, and this training sequence includes the reference sequence. Note that the reference sequence obtaining unit 116 may generate first-order modulated symbols on the basis of the generated reference sequence, in which case the mapping unit 104 may be omitted. As described above, the reference sequence obtaining unit 116 obtains a reference sequence for data, the reference sequence for data having a reference sequence given a phase rotation depending on an information sequence to be transmitted, the reference sequence having a symbol sequence length equal to or smaller than the modulation order of the modulation method used for data transmission. Note that the reference sequence obtaining unit 116 and the reference sequence obtaining unit 106 may be integrated into a single reference sequence obtaining unit. In this case, the reference sequence obtaining unit generates both of a reference sequence for a training sequence and a data reference sequence for a data symbol sequence. In addition, a reference sequence that is a CAZAC sequence may be similarly applied to a data symbol sequence in the transmission device 10 illustrated in FIG. 1 and the transmission device 10A illustrated in FIG. 7.

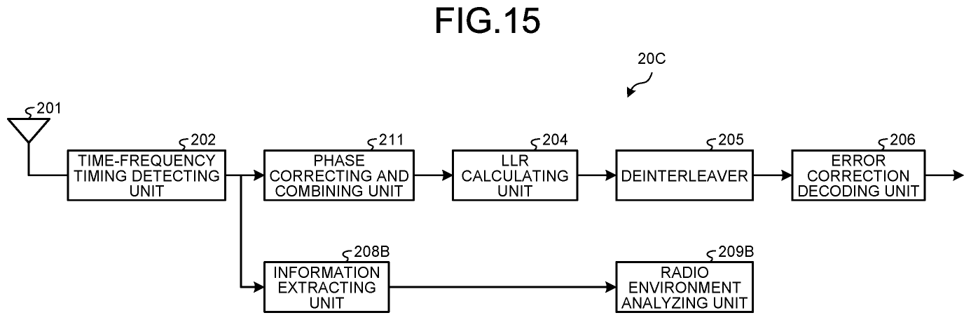

FIG. 15 is a diagram illustrating a configuration of a reception device in a case where a reference sequence that is a CAZAC sequence is applied to a data symbol sequence. In a reception device 20C illustrated in FIG. 15, for input to the LLR calculating unit 204, a phase correcting and combining unit 211 performs a phase correction and combining process on a received signal on the basis of a reference sequence. In the case of two-bit transmission as described above, the phase correcting and combining unit 211 multiplies each reference sequence, that is, each of the four sequence patterns by a reverse rotation amount of the phase rotation amount of the CAZAC sequence, and combines the four symbols. In this example, because the same phase rotation is applied to the four symbols in a period as described above, an average of the four symbols, for example, is obtained in the combining process. As a result of the process of averaging the four symbols in this manner, noise can be reduced, and the signal to noise ratio can be improved. As a result of the phase correction and combining process, any of candidate signal points 0, 2, 4, and 6 can be obtained as a candidate for a starting point corresponding to the initial phase, and the phase correcting and combining unit 211 thus inputs the candidate signal point to the LLR calculating unit 204. As described above, the phase correcting and combining unit 211 is a processing unit that gives a received signal a phase rotation, which is a reverse of a phase rotation given to each candidate for a data reference sequence to be transmitted in the transmission device, and combine the received signal resulting from the phase rotation, with symbols amounting to the data reference sequence. Note that the preprocessing before the LLR calculating unit 204 is not limited to the processes described above, and each reference sequence may be multiplied by a reverse rotation amount of the phase rotation amount of the CAZAC sequence after delay detection, and the combining process may then be performed. While two-bit transmission in one pattern of the reference sequence that is a CAZAC sequence and four patterns of the initial phase is performed in the example described above, the patterns of the reference sequence that is a CAZAC sequence and the initial phase are not limited to those described above. The control unit 110 may provide an instruction on use of a pattern, that is, an instruction on which value of a bit sequence is to be applied to which pattern.

While FIG. 14 illustrates an example in which a CAZAC sequence is applied to each of a training sequence and a data symbol sequence, a CAZAC sequence may be applied to a data symbol sequence but not to a training sequence.

As described above, a reference sequence is generated as in the case where information is given to an initial phase and a CAZAC sequence is applied to a training sequence. As a result, degradation in the PAPR of the waveform can also be minimized as a CAZAC sequence is applied to an information sequence as well without changing the modulation method.

Next, a hardware configuration of the transmission devices 10, 10A, 10B, and 10C and the reception devices 20, 20B, and 20C according to the first and second embodiments will be described. The components of the transmission devices 10, 10A, 10B, and 10C and the reception devices 20, 20B, 20C are implemented by processing circuitry. The processing circuitry may be implemented by dedicated hardware, or may be a control circuit using a central processing unit (CPU).

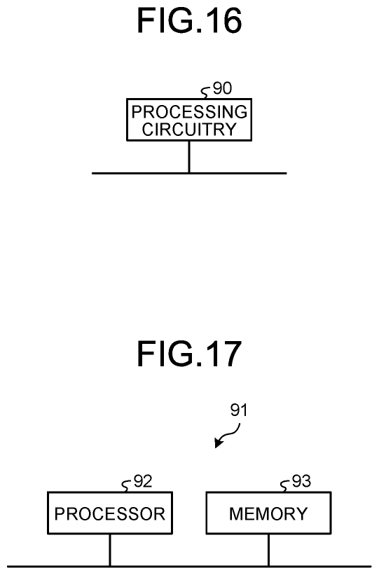

In a case where the processing circuitry is implemented by dedicated hardware, the functions are implemented by processing circuitry 90 illustrated in FIG. 16. FIG. 16 is a diagram illustrating dedicated hardware for implementing the functions of the transmission devices 10, 10A, 10B, and 10C and the reception devices 20, 20B, and 20C according to the first and second embodiments. The processing circuitry 90 is a single circuit, a composite circuit, a programmed processor, a parallel-programmed processor, an application specific integrated circuit (ASIC), a field programmable gate array (FPGA), or a combination thereof.

In a case where the processing circuitry is implemented by a control circuit using a CPU, the control circuit is a control circuit 91 having a configuration illustrated in FIG. 17, for example. FIG. 17 is a diagram illustrating a configuration of the control circuit 91 for implementing the functions of the transmission devices 10, 10A, 10B, and 10C and the reception devices 20, 20B, and 20C according to the first and second embodiments. As illustrated in FIG. 17, the control circuit 91 includes a processor 92, and a memory 93. The processor 92 is a CPU, and is also referred to as a computing device, a microprocessor, a microcomputer, a digital signal processor (DSP), or the like. The memory 93 is a nonvolatile or volatile semiconductor memory such as a random access memory (RAM), a read only memory (ROM), a flash memory, an erasable programmable ROM (EPROM), or an electrically EPROM (EEPROM; registered trademark), a magnetic disk, a flexible disk, an optical disk, a compact disc, a mini disc, a digital versatile disk (DVD), or the like, for example.

In a case where the processing circuitry is implemented by the control circuit 91, the processing circuitry is implemented by the processor 92 reading and executing programs corresponding to the processes of the respective components stored in the memory 93. In addition, the memory 93 is also used as a temporary memory in processes performed by the processor 92. Note that programs to be executed by the processor 92 may be provided via a communication channel, or may be stored on a storage medium and provided therefrom.

A transmission device according to the present disclosure produces the effect of minimizing degradation in the PAPR of the waveform without changing the modulation method when performing transmission using the CAZAC sequence.

The configurations presented in the embodiments above are examples, and can be combined with other known technologies or with each other, or can be partly omitted or modified without departing from the gist.

What is claimed is:

1. A transmission device comprising:
reference sequence obtaining circuitry to obtain a reference sequence having a symbol sequence length equal to or smaller than a modulation order in a modulation method used for data transmission, the reference sequence having a constant amplitude in a time domain and a frequency domain;
training sequence generating circuitry to generate a training sequence including the reference sequence; and
transmission circuitry to transmit a signal including the training sequence, wherein
the reference sequence obtaining circuitry determines a sequence length of the reference sequence so that an integral multiple of the sequence length of the reference sequence is equal to the modulation order or to a value obtained by dividing the modulation order by 2, and
the reference sequence obtaining circuitry generates a constant amplitude zero auto-correlation sequence having possible constellations in the modulation method, on the basis of an order determined from the constellations in the modulation method, parameters of the constant amplitude zero auto-correlation sequence being determined on the basis of parameters of the modulation method.

2. The transmission device according to claim 1, wherein
the reference sequence obtaining circuitry regards n/4-shift differential quadrature phase shift keying as a set of constellations of 8-phase shift keying, and generates the constant amplitude zero auto-correlation sequence with possible constellations in n/4-shift quadrature phase shift keying temporally corresponding to even symbols and odd symbols.

3. The transmission device according to claim 1, wherein
the reference sequence obtaining circuitry obtains the reference sequence that is a bit sequence,
the training sequence generating circuitry generates the training sequence that is a bit sequence including the reference sequence, and
the transmission circuitry multiplexes a data symbol sequence and the training sequence on a bit-by-bit basis, and generates a transmission sequence including the data symbol sequence and the constant amplitude zero auto-correlation sequence conforming to a rule associated with the modulation method.

4. The transmission device according to claim 2, wherein
the reference sequence obtaining circuitry obtains the reference sequence that is a bit sequence,
the training sequence generating circuitry generates the training sequence that is a bit sequence including the reference sequence, and
the transmission circuitry multiplexes a data symbol sequence and the training sequence on a bit-by-bit basis, and generates a transmission sequence including the data symbol sequence and the constant amplitude zero auto-correlation sequence conforming to a rule associated with the modulation method.

5. The transmission device according to claim 1, further comprising:
data reference sequence obtaining circuitry to generate a reference sequence for data, the reference sequence for data having a reference sequence given a phase rotation, the reference sequence having a symbol sequence length equal to or smaller than a modulation order of a modulation method used for data transmission, the phase rotation depending on an information sequence to be transmitted, wherein
the signal includes the reference sequence for data.

6. The transmission device according to claim 2, further comprising:
data reference sequence obtaining circuitry to generate a reference sequence for data, the reference sequence for data having a reference sequence given a phase rotation, the reference sequence having a symbol sequence length equal to or smaller than a modulation order of a modulation method used for data transmission, the phase rotation depending on an information sequence to be transmitted, wherein
the signal includes the reference sequence for data.

7. The transmission device according to claim 3, further comprising:
data reference sequence obtaining circuitry to generate a reference sequence for data, the reference sequence for data having a reference sequence given a phase rotation, the reference sequence having a symbol sequence length equal to or smaller than a modulation order of a modulation method used for data transmission, the phase rotation depending on an information sequence to be transmitted, wherein
the signal includes the reference sequence for data.

8. The transmission device according to claim 4, further comprising:
data reference sequence obtaining circuitry to generate a reference sequence for data, the reference sequence for data having a reference sequence given a phase rotation, the reference sequence having a symbol sequence length equal to or smaller than a modulation order of a modulation method used for data transmission, the phase rotation depending on an information sequence to be transmitted, wherein
the signal includes the reference sequence for data.

9. A transmission device comprising:
reference sequence obtaining circuitry to obtain a reference sequence having a symbol sequence length equal to or smaller than a modulation order in a modulation method used for data transmission, the reference sequence having a constant amplitude in a time domain and a frequency domain; and
transmission circuitry to transmit a signal including the reference sequence, wherein
the reference sequence obtaining circuitry generates a reference sequence for data, the reference sequence for data having the reference sequence given a phase rotation, the reference sequence having a symbol sequence length equal to or smaller than a modulation order of a modulation method used for data transmission, the phase rotation depending on an information sequence to be transmitted, and
the signal includes the reference sequence for data.

10. A reception device for receiving a signal transmitted by the transmission device according to claim 5, the reception device comprising:
information extracting circuitry to extract radio environment information on a desired wave on the basis of a received signal; and
processing circuitry to give the received signal a phase rotation, the phase rotation being a reverse of a phase rotation given to each candidate for a data reference sequence to be transmitted in the transmission device, and combine the received signal resulting from the phase rotation, with symbols corresponding to the data reference sequence.

11. A reception device for receiving a signal transmitted by the transmission device according to claim 6, the reception device comprising:
information extracting circuitry to extract radio environment information on a desired wave on the basis of a received signal; and
processing circuitry to give the received signal a phase rotation, the phase rotation being a reverse of a phase rotation given to each candidate for a data reference sequence to be transmitted in the transmission device, and combine the received signal resulting from the phase rotation, with symbols corresponding to the data reference sequence.

12. A reception device for receiving a signal transmitted by the transmission device according to claim 7, the reception device comprising:
information extracting circuitry to extract radio environment information on a desired wave on the basis of a received signal; and
processing circuitry to give the received signal a phase rotation, the phase rotation being a reverse of a phase rotation given to each candidate for a data reference sequence to be transmitted in the transmission device, and combine the received signal resulting from the phase rotation, with symbols corresponding to the data reference sequence.

13. A reception device for receiving a signal transmitted by the transmission device according to claim 8, the reception device comprising:
information extracting circuitry to extract radio environment information on a desired wave on the basis of a received signal; and
processing circuitry to give the received signal a phase rotation, the phase rotation being a reverse of a phase rotation given to each candidate for a data reference sequence to be transmitted in the transmission device, and combine the received signal resulting from the phase rotation, with symbols corresponding to the data reference sequence.

14. A reception device for receiving a signal transmitted by the transmission device according to claim 9, the reception device comprising:
information extracting circuitry to extract radio environment information on a desired wave on the basis of a received signal; and
processing circuitry to give the received signal a phase rotation, the phase rotation being a reverse of a phase rotation given to each candidate for a data reference sequence to be transmitted in the transmission device, and combine the received signal resulting from the phase rotation, with symbols corresponding to the data reference sequence.
